(19) United States
(12) Patent Application Publication
(10) Pub. No.: US 2003/0057047 A1
(43) Pub. Date: Mar. 27, 2003

(54) Mechanical overrun clutch with magnetically biased pawl and ratchet assembly

(76) Inventor: Feng Jin, Tianjin (CN)

Correspondence Address: Sherman D. Pernia, Suite 450, 1110 NASA Road One, Houston, TX, 77058-3310, US

(21) Appl. No.: 10/022,079

(22) Filed: Dec. 13, 2001

(30) Foreign Application Priority Data
Jun. 18, 2001 (CN) 01129231.8
Jun. 25, 2001 PCT/CN01/01038

(51) Int. Cl. F16D 41/12

(52) U.S. Cl. 192/46; 192/84.3

(57) ABSTRACT

A mechanical overrun clutch drive and driven assemblies are disengaged in an overrun situation by a magnetically biases pawl and ratchet assembly. The ratchet assembly is disposed between the drive and driven assembly, and is operative upon an overrun condition of the clutch driven assembly relative to the drive assembly to disengage the clutch drive and driven assembly and allow the driven assembly to freely rotate. Permanent magnets magnetically biased the pawls mounted on the drive assembly into unidirectional engagement with the saw teeth of an internal ring gear mounted to the clutch driven assembly. The magnets are isolated from physical contact with the pawls they bias by an air gap or airspace, to prevent the pawls from mechanically impacting the magnets during operation of the clutch.

### BACKGROUND OF THE INVENTION

Field of the Invention. The present invention is in the field of mechanical clutch mechanisms. More specifically, the present invention relates to combination magnetic-centrifugal clutches having pawl and ratchet structures where the interlocking engagement of the driving and driven clutch parts is effected in part by the magnetic attraction between the elements of the clutch.

Mechanical pawl and ratchet clutches are known and used in unidirectional drive train, such a pumping unit on a well (e.g., an oil well), for transmitting rotational force (torque) from a drive mechanism to a driven mechanism. An “overrun” type clutch allows the drive and driven mechanisms of the drive train to disengage when the driven mechanism rotates faster then drive mechanism.

An example of such a mechanical pawl and ratchet overrun clutch is disclosed in U.S. Pat. No. 4,914,906 to Burch. However, because of certain perceived limitations on Burch-type devices, others in the field were motivated to develop alternative clutch assemblies.

For example, the U.S. Pat. No. 5,205,386 to Goodman et al. describes a type of pawl and ratchet clutch wherein the pawls are biased to engage the ratchet by a spring mechanism and simultaneously to disengage the ratchet by a magnet in combination with centrifugal force of rotation. When the rotation rate is over the optimized value, the pawl moves outwards radially under centrifugal force to contact the magnet. Once the pawl contacts the magnet, the ratchet pawl will be retained disengaged by the combination of the magnetic and centrifugal forces. The Goodman clutch uses a spring to bias the pawl into engagement with the ratchet. In applications where a drive train is frequently in the overrun condition, the spring of Goodman can become fatigued, and over time cause a change in the biasing force of the spring which alter the threshold rotation at which the clutch engages and disengages. Additionally, in a frequent overrun situation, during the operation of a Goodman-type clutch, the magnet and the pawl are constantly physically contacting and bumping against each other. This can result in the damage to the magnet or the magnet becoming overheated. The physical damage to the magnets can cause the malfunction of the clutch. Over heating a magnet can cause it shrink, and therefore may eventually loosen, resulting in the malfunction of the clutch.

Therefore, it would be beneficial in the field to have an alternative mechanical overrun clutch that did not utilize a pawl and ratchet assembly having bias springs, or having bias magnets subject to physical impact during engagement and disengagement of the clutch in the drive train.

### BRIEF SUMMARY OF THE INVENTION

The present invention is a mechanical overrun clutch having a ratchet assembly utilizing a magnetic field to bias the pawls and ratchet wheel of the assembly to engage. The present mechanical overrun clutch does not utilize bias springs. Additionally, the permanent magnets which generate the magnetic fields do not themselves physical contact the pawls during engagement and disengagement of the clutch. The mechanical overrun clutch comprising a clutch drive assembly, a clutch driven assembly, and a magnetically biased ratchet assembly to accomplish engagement of the drive and driven assemblies. The drive assembly is rotatable about an axis of rotation by a drive mechanism external to the clutch. The clutch driven assembly has an axis of rotation in common with the drive assembly and rotatable about the axis of rotation by the rotation of the clutch drive assembly when it is engaged via operation of the ratchet assembly. The ratchet assembly is disposed between the drive assembly and the driven assembly. The ratchet assembly is operative upon the appropriate rotation of the clutch drive assembly to engage the clutch drive assembly with the clutch driven assembly and to transfer torque to the clutch driven assembly. Further, the ratchet assembly disengages upon the inappropriate rotation of the drive assembly relative to the driven assembly, i.e., an “overrun” condition. An “overrun” situation occurs when the rotation rate of the driven assembly exceeds the rotation rate of the drive assembly. In such a situation, the present clutch disengages and the driven assembly is allowed to ratchet freely.

The clutch drive assembly has an axis of rotation, about which it is rotatable by a drive mechanism, and having a ratchet plate, the ratchet plate being substantially circular and having a center on and radii perpendicular the axis of rotation, at which center is disposed a means for attaching the drive assembly to a drive mechanism. The clutch drive assembly comprises a substantially circular ratchet plate. The ratchet plate has its center on the axis of rotation and the plane of the plate is perpendicular to the axis. At the center of the ratchet plate is disposed a connecting means for receiving and fixing the drive assembly in rotational communication a drive mechanism. Typically, this connecting means is a shaft bore for receiving and rotationally communicating with the axial shaft. To accomplish this, the shaft bore is configured to compliment and closely receive the axial shaft. Complimentary configuration of the axial shaft and shaft bore are known to and readily practicable in the present invention by the ordinary skilled artisan. Examples include, keyed and splined shafts and complimentary bores.

The clutch driven assembly comprises a housing having a substantially cylindrical interior and a substantially cylindrical interior wall. The housing has an axis of rotation in common with the drive assembly and is rotatable about the axis of rotation. The housing receives and contains the ratchet assembly and the clutch drive assembly. The housing is in rotational communication with an external driven mechanism to which the rotation of the housing is imparted.

Being held fixed in the drive assembly housing, the ratchet wheel is also subject to rotational communication with the drive mechanism and rotates about the axis of rotation with the housing.

The ratchet assembly of the present invention comprises a ratchet wheel and an associated plurality of ratchet pawls and biasing magnets. The ratchet wheel is received and held fixed in the housing of the clutch drive assembly. The ratchet wheel comprises an internal toothed ring gear with the teeth being ratchet teeth and configured to unidirectionally engage the ratchet pawls of the ratchet assembly. The engagement is unidirectional in that the ratchet pawls engage the gear teeth of the ratchet wheel when the relative rotation (of the drive to the driven assembly) is in one direction, and do not engage the gear teeth when relative rotation is in the other direction. The ratchet pawls and biasing magnets are mounted on the ratchet plate. More specifically, the plurality of ratchet pawls are each pivotably mounted on a separate pawl axle. The pawl axles are fixed to the ratchet plate of the clutch driven assembly at equal radial distances from the axis of rotation of the driven assembly. An equal number of permanent magnets are fixed to the drive assembly for biasing the ratchet pawls into the engaged position. This is accomplished by positioning a magnet relative to each ratchet pawl to have its magnetic field affect a portion of the associated ratchet pawl and bias the pawl to pivot on its pawl axle into the engagement position.

To accomplish the magnetic biasing of the ratchet pawls, the pawls are composed of a para-magnetic material susceptible to a magnetic field. The ratchet pawls have a gearing or gear engaging section, a mid-section and a tail section. The mid-section has an axle bore for receiving and pivotably mounting the ratchet pawl to the pawl axle. Distal to the mid-section, the gearing section has a gearing end for engaging with the ratchet wheel fixed in the housing of the clutch drive assembly. Distal to the mid-section, the tail section has a tail end. The tail section is acted on by the magnetic field of the associated biasing magnet, to pivot the ratchet pawl and bias its gearing end into an engagement position with the drive assembly.

The distance from the gearing end to the center of the axle bore of a ratchet pawl is larger than the distance from its tail end to the center of the axle bore. This allows a movement of the tail end of the ratchet pawl to impart a greater arc of movement to the gearing end. A ratio of the distances between the gearing end to the center of the axle bore and the tail end to the center of the axle bore of about 1.1 to 1.0 has been beneficially utilized in the ratchet pawls.

The biasing magnets are permanent magnets. Each biasing magnet is located on a radius of the axis of rotation intersecting the tail end of the pawl with which it is associated. The permanent magnets are made of a permanent magnet material such as an iron-oxide material or a neodymium-iron-boron material. The biasing magnets are isolated from direct physical contact with the ratchet pawls and with the clutch drive assembly.

Isolation from the drive assembly is accomplished by having each magnet first fixed to a non-magnetic material, and then having the non-magnetic material fixed to the clutch drive assembly. For example, each magnet may be received in a sleeve made of a non-magnetic material, such as stainless steel, copper or aluminum, and the sleeve then being fixed in a recess on the clutch drive assembly to isolate the magnet from direct contact with the drive assembly.

Isolation of the biasing magnets from the ratchet pawls is accomplished by limiting the pivotal travel of the ratchet pawl and having each magnet is positioned relative to the ratchet pawl to avoid contacting the pawl at the point of closest approach of its tail end toward the magnet. Although the tail end of the ratchet pawl never contacts the magnet, the biasing magnet still magnetically affects the ratchet pawl during rotation of the drive and driven assemblies relative to each other. Each magnet is positioned relative to its associated ratchet pawl to maintain an air gap or air space separation of at least about 1 mm at the point of closest approach of the tail end of the ratchet pawl toward the magnet.

### BRIEF DESCRIPTION OF THE SEVERAL VIEWS OF THE DRAWINGS

FIG. 1 is a partial cross-sectional view down the axis of rotation of the clutch.

FIG. 2 is a cross-sectional view along the axis of rotation of the clutch.

### DETAILED DESCRIPTION OF THE INVENTION

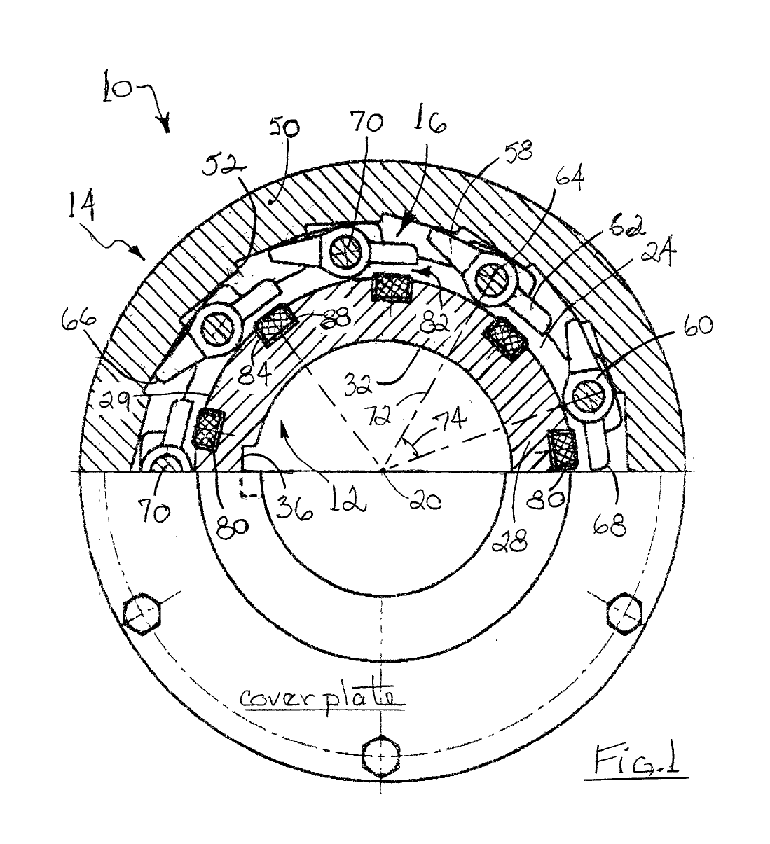

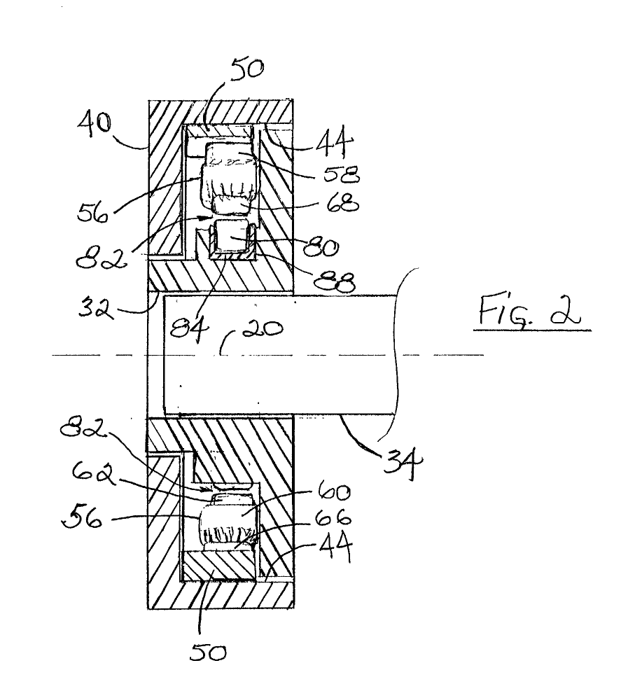

Referring now to the drawings, the details of preferred embodiments of the present invention are graphically and schematically illustrated. Like elements in the drawings are represented by like numbers, and any similar elements are represented by like numbers with a different lower case letter suffix. As shown in FIGS. 1 and 2, the present invention is a mechanical overrun clutch 10. The clutch 10 comprises: a clutch drive assembly 12; a clutch driven assembly 14; a ratchet assembly 16 and an axis of rotation 20 common to both the drive assembly 12 and the driven assembly 14.

The clutch drive assembly 12 is rotatable about the axis of rotation 20 by a drive mechanism (not shown). The drive assembly further comprises a ratchet plate 24, the ratchet plate 24 being substantially circular and having its center on the axis of rotation and extending radially and perpendicularly therefrom (see FIGS. 1 and 2). At the center of the ratchet plate is a drive hub 28, disposed to include an attaching means 32 for attaching the ratchet plate 24 of the drive assembly 12 to the drive mechanism. In a preferred embodiment, the attaching means 32 of the drive hub 28 a shaft bore 32 through the center of the hub 28 along the axis of rotation 20. The shaft bore 32 mates with the output shaft 34 of the drive mechanism and fixes the two together so that rotation of the output shaft 34 is directly communicated to the clutch drive assembly 12 via the drive assembly hub 28. Means for fixably mating an output shaft 34 with the shaft bore 32 are known to the ordinary skilled artisan and readily practicable in the present invention. For example, the hub bore 32 and the output shaft can be complementary threaded. Alternatively, as shown in the preferred embodiment of FIG. 1, the hub bore 32 includes a key-way 36, for mating the cross-section of the hub bore 32 with a complimentary cross section of the output shaft 32 of the drive mechanism.

The clutch driven assembly 14 is also rotatable about the axis of rotation 20. The clutch driven assembly 14 comprises a housing 40 having a substantially cylindrical interior space and a substantially cylindrical interior wall 44. The housing 40 is disposed to receive and contain the ratchet assembly 16 and the clutch drive assembly 14.

The ratchet assembly 16 is disposed in mechanical communication with both the drive assembly 12 and the driven assembly 14. The ratchet assembly 16 is operative upon appropriate rotation of the clutch drive assembly 12 relative to the driven assembly 14 to engage the clutch drive assembly 12 with the clutch driven assembly 14, to rotate the clutch driven assembly 14. Additionally, the ratchet assembly 16 disengages the drive 12 and driven 14 assemblies upon the inappropriate rotation (“overrun” condition) of the driven assembly 14 relative to the drive assembly 12. In such a situation, the present clutch 10 disengages and the driven assembly 14 is allowed to ratchet freely.

As shown in FIG. 1, the ratchet assembly comprises a ratchet wheel 50 fixedly received inside the housing 40 the driven assembly 14, and a plurality of ratchet pawls 56 pivotably mounted on pawl axles 66, and an equal plurality of permanent magnets 80 fixed to the outer surface 29 of the drive hub 28.

The ratchet wheel 50 is configured as an internal toothed ring gear with the gear teeth 52 of the ring gear disposed to unidirectionally engage the ratchet pawls 56 of the ratchet assembly 16. The ratchet wheel 50 may be a separate component and fixed to an interior surface of the housing 40, such as the interior cylindrical wall 44, using a means known to and practicable by the ordinary skilled artisan, such as threaded fasteners. Alternatively, the ratchet wheel 50 may be cast or milled into integral to an interior surface of the housing 40, such as the interior cylindrical wall 44.

The ratchet pawls 56 are made of a para-magnetic material. Each pawl 56 has a gearing section 58, a mid-section 60 and a tail section 62. In the mid-section 60 of the pawl 56 is disposed an axle bore 64. The axle bore 64 receives and pivotably mounts the ratchet pawl 56 to a pawl axle 70. The gearing section 58 of the pawl 56 has a gearing end or gearing surface 66 for engaging with the gear teeth 52 of the ratchet wheel 50. The tail section 62 of the pawl 56 extends away from the mid-section 60 opposite the gearing section 58. The para-magnetic material of the tail section 62 is acted on by the magnetic field of a magnet 80 to pivot the ratchet pawl 56 and bias the gearing end 66 of the gearing section 58 into a position to engage with the gear teeth 52 of the ratchet wheel 50. The distance from the gearing end 66 of the pawl 56 to the center of the axle bore 64 is greater than the distance from the tail end 68 of the tail section 62 to the center of the axle bore 64. In the preferred embodiment, the ratio of the distances between the gearing end 66 of the gearing section 58 to the center of the axle bore 64 and the tail end 68 of the tail section 62 to the center of the axle bore 64 was about 1.1 to 1.0. The pawl axles 70 are fixed to the ratchet plate 24 of the drive assembly 12 at equal radial distances 72 from the axis of rotation 20 of the drive assembly. The angular separation 74 of the pawl axles 70 may be the same, or as shown in FIG. 1, they may be different.

A plurality of permanent magnets 80 equal to the number of ratchet pawls 56 are fixed to the outer surface 29 of the drive hub 28. In the preferred embodiment shown in the figures, the magnets 80 were columnar shaped. Permanent magnets and the materials for making them are known in the art. Such materials include iron-oxide and neodymium-iron-boron materials. The magnets 80 are disposed on the drive hub outer surface 29 to have it magnetic field impinge on the associated ratchet pawl 56 to bias the pawl 56 to pivot on its pawl axle 70 into an engagement position relative to the gear teeth 52 of the ratchet wheel 50. The permanent magnets 80 are each located on a radius of the axis of rotation 20 intersecting the tail section 62 of the associated ratchet pawl 56. In the preferred embodiment shown in FIG. 1, the magnets 80 are isolated from direct physical contact with their associated ratchet pawls 56 by an air space, and also from the drive hub 28 of the clutch drive assembly 12 by a non-magnetic material 84.

Each magnet 80 was isolated from direct contact with drive hub 28 by first attaching the magnet 80 to a non-magnetic material 84. After the magnet 80 was fixed to a non-magnetic material 84, and the non-magnetic material 84 was in turn fixed to the drive hub 28 of the clutch drive assembly 12 to isolate the magnet 80 from direct physical contact with the drive hub 28. In the preferred embodiment shown in FIG. 1, each magnet 80 was inserted into a non-magnetic material 84 formed as a closed end sleeve 84a. Non-magnetic materials for constructiong the sleeves 84a are known in the art and include stainless steel, copper and aluminum. In turn, the sleeve 84a containing the magnet 80 was fixed in a recess 88 on the drive hub 28 of the clutch drive assembly 12 to isolate the magnet from direct physical contact with the drive hub 28.

The airspace 82 which separates each magnet 80 from its associated pawl 56 is accomplished by positioning each magnet 80 relative to its associated ratchet pawl 56 to avoid physically contacting the pawl 56 during rotation of the drive assembly 12, while still magnetically affecting the tail section 62 of the pawl 56. The size of the magnet 80 (and hence the strength of its magnetic field), the para-magnetic mass of the tail section 62 and the desired minimum and maximum range of the airspace are all considered by the ordinary skilled artisan to select the size and shape of the magnets 80, the tail sections 62 to achieve the desired biasing of the pawls 56 into engagement with the ratchet wheel 50. In the preferred embodiment shown in the figures, each magnet 80 was positioned relative to the associated ratchet pawl 56 to maintain a minimum air space of at least about 1 mm, while still magnetically biasing the ratchet pawl 56 during rotation of the drive 12 and driven 14 assemblies relative to each other.

While the above description contains many specifics, these should not be construed as limitations on the scope of the invention, but rather as exemplifications of one or another preferred embodiment thereof. Many other variations are possible, which would be obvious to one skilled in the art. Accordingly, the scope of the invention should be determined by the scope of the appended claims and their equivalents, and not just by the embodiments.

What is claimed is:

1. A mechanical overrun clutch comprising:
a clutch drive assembly, the drive assembly having an axis of rotation and being rotatable about the axis of rotation by a drive mechanism, and having a ratchet plate, the ratchet plate being substantially circular and having a center on and radii perpendicular the axis of rotation, at which center is disposed a means for attaching the drive assembly to a drive mechanism.
a clutch driven assembly, the driven assembly having an axis of rotation in common with the drive assembly and being rotatable about the axis of rotation; and
a ratchet assembly disposed in mechanical communication with the drive assembly and the driven assembly, and operative upon an appropriate rotation of the clutch drive assembly relative to the driven assembly to engage the clutch drive assembly with the clutch driven assembly and to rotate the clutch driven assembly, and to disengage upon an overrun rotation of the driven assembly relative to the drive assembly.

2. The clutch drive assembly of claim 2, wherein the means for attaching to the drive mechanism is a shaft bore, the shaft bore for fixably receiving and being rotated by a drive shaft of the drive mechanism.

3. The mechanical overrun clutch of claim 1, wherein the clutch driven assembly comprises a housing having a substantially cylindrical interior and a substantially cylindrical interior wall, and disposed to receive and contain the ratchet assembly and the clutch drive assembly.

4. The mechanical overrun clutch of claim 1, wherein the ratchet assembly comprises a ratchet wheel fixedly received in the driven assembly, and a plurality of ratchet pawls pivotably mounted on pawl axles, the pawl axles being fixed to the drive assembly at equal radial distances and from the axis of rotation of the drive assembly, and an equal plurality of permanent magnets fixed to the drive assembly, the magnets each having a magnetic field affecting a ratchet pawl to bias the pawl to pivot on its pawl axle into an engagement position with the ratchet wheel.

5. The ratchet assembly of claim 4, wherein the ratchet wheel comprises an internal toothed ring gear with the teeth of the ring gear configured to unidirectionally engage the ratchet pawls of the ratchet assembly.

6. The ratchet assembly of claim 4, wherein the ratchet pawls are comprised of a para-magnetic material and have a gearing section, a mid-section and a tail section, the mid-section having an axle bore for receiving and pivotably mounting the ratchet pawl to the ratchet axle, the gearing section having a gearing end for engaging with the ratchet wheel and the tail section for being acted on by the magnetic field to pivot the ratchet pawl and bias the gearing end of the gearing section into an engagement position with the ratchet wheel.

7. The ratchet assembly of claim 4, wherein the permanent magnets are each located on a radius of the axis of rotation intersecting a tail section of a ratchet pawl.

8. The ratchet assembly of claim 4, wherein the permanent magnets are isolated from direct physical contact with the ratchet pawls by a minimum air space and from the clutch drive assembly by a non-magnetic material.

9. The permanent magnets of claim 8, wherein each magnet is fixed to a non-magnetic material, and the non-magnetic material is fixed to the clutch drive assembly to isolate the magnet from direct physical contact with the drive assembly.

10. The permanent magnets of claim 8, wherein each magnet is received in a sleeve made of a non-magnetic material selected from the group consisting of stainless steel, copper and aluminum, and the sleeve is fixed in a recess on the clutch driven assembly to isolate the magnet from direct physical contact with the drive assembly.

11. The permanent magnets of claim 8, wherein each magnet is positioned relative to the ratchet pawl to avoid physically contacting the pawl while still magnetically affecting the tail section of the ratchet pawl during rotation of the drive assembly.

12. The permanent magnets of claim 8, wherein each magnet is positioned relative to the ratchet pawl to maintain the minimum air space at at least about 1 mm while still magnetically affecting the ratchet pawl during rotation of the drive and driven assemblies relative to each other.

13. The permanent magnets of claim 4, wherein each magnet is columnar shaped and is made of a permanent magnet material selected from the group consisting of iron-oxide material and neodymium-iron-boron material.

14. The ratchet pawls of claim 6, wherein a distance from the gearing end to a center of the axle bore is greater than a distance from a tail end of the tail section to the center of the axle bore.

15. The ratchet pawls of claim 6, wherein a ratio of the distances between the gearing end to a center of the axle hole and a tail end of the tail section to the center of the axle bore is about 1.1 to 1.0.

16. A mechanical overrun clutch comprising:
a clutch drive assembly, the drive assembly having an axis of rotation and being rotatable about the axis of rotation by a drive mechanism, and having a ratchet plate, the ratchet plate being substantially circular and having a center on and radii perpendicular the axis of rotation, at which center is disposed a means for attaching the drive assembly to a drive mechanism.
a clutch driven assembly, the driven assembly further comprising a housing having a substantially cylindrical interior and a substantially cylindrical interior wall, with the housing having an axis of rotation in common with the drive assembly and being rotatable about the axis of rotation and disposed to receive and contain the ratchet assembly and the clutch drive assembly; and
a ratchet assembly disposed in mechanical communication with the drive assembly and the driven assembly, and further comprising a ratchet wheel received in the drive assembly, and a plurality of ratchet pawls pivotably mounted on pawl axles, the pawl axles being fixed to the drive assembly at equal radial distances from the axis of rotation of the drive assembly, and an equal plurality of permanent magnets fixed to the drive assembly, the magnets each having a magnetic field affecting a ratchet pawl to bias the pawl to pivot on its pawl axle into an engagement position with the ratchet wheel and the permanent magnets being isolated from direct physical contact with the ratchet pawls by a minimum air space and from the clutch drive assembly by a non-magnetic material, and the ratchet assembly operative upon an appropriate rotation of the clutch drive assembly relative to the driven assembly to engage the clutch drive assembly with the clutch driven assembly and to rotate the clutch driven assembly, and to disengage upon an overrun rotation of the driven assembly relative to the drive assembly.

17. A pawl and ratchet assembly for a mechanical overrun clutch, the ratchet assembly operative upon an overrun condition of the clutch's driven assembly relative to the clutch's drive assembly to disengage the driven assembly from the drive assembly, the pawl and ratchet assembly comprising:
a ratchet wheel mounted to a clutch driven assembly, the ratchet wheel being an internal toothed ring gear with the gear teeth of the ring gear in a saw-tooth configuration to unidirectionally engage a ratchet pawl;
a plurality of pawl axles fixed to a clutch drive assembly at equal radial distances from an axis of rotation of the drive assembly;
an equal plurality of para-magnetic ratchet pawls pivotably mounted on the pawl axles, each pawl having a gearing section, a mid-section and a tail section with an axle bore disposed in the mid-section of each pawl for receiving a pawl axle, the gearing section having a gearing end for engaging with the gear teeth of the ratchet wheel, the tail section extending away from the mid-section opposite the gearing section, with a distance from the gearing end of the pawl to a center of the axle bore is greater than a distance from a tail end of the tail section to the center of the axle bore.
an equal plurality of permanent magnets fixed to the drive assembly, the magnets each having a magnetic field affecting the tail section of a ratchet pawl to bias the pawl to pivot on its pawl axle to bring the gearing end into an engagement position with the gear teeth of the ratchet wheel, and the permanent magnets being isolated from direct physical contact with the ratchet pawls by a minimum air space, and from direct physical contact with the clutch drive assembly by a non-magnetic material.
